(19) United States
(12) Patent Application Publication
(10) Pub. No.: US 2009/0255917 A1
(43) Pub. Date: Oct. 15, 2009

(54) ELECTRICALLY-HEATED, INSULATED WARMING BAG FOR IGNITION SYSTEM INTERLOCK DEVICE

(76) Inventors: Stefan Blair Feichko, Price, UT (US); William Scott Thompson, American Fork, UT (US)

Correspondence Address: ANGUS C. FOX, III, 4093 N. IMPERIAL WAY, PROVO, UT, 84604-5386, US

(21) Appl. No.: 12/103,052

(22) Filed: Apr. 15, 2008

(51) Int. Cl. H05B 3/36; H05B 3/00

(52) U.S. Cl. 219/386; 29/611

(57) ABSTRACT

An electrically-heated insulated warming bag, in which the handheld unit of an ignition interlock device can be stored while not in use so that the handheld unit can be used on cold days without experiencing condensation problems, plugs into a cigarette lighter receptacle. The warming bag, which has resistive wire pattern sandwiched between an insulation layer and an inner lining layer, also has an outer cover which overlies the insulation layer. The stack, consisting of the outer cover, the insulation layer, the resistive wire pattern, and the inner lining layer, is folded over and sewn around the resulting perimeter to create the bag. One side, which is left open to provide entry to the interior of the bag, is sealable by means of hook and loop fastener strips, which are sewn to inside opposite edges of the opening. The bag may incorporate a thermostat to minimize power consumption.

### BACKGROUND OF THE INVENTION

1. Field of the Invention

The invention relates, generally, to electrically-heated warming devices and more particularly, to an electrically-heated, insulated warming bag for an ignition system interlock device.

2. History of the Prior Art

According to National Highway Transportation Safety Administration statistics for the year 2005, alcohol-related motor vehicle crashes kill someone in the U.S. every 31 minutes. In addition, every two minutes, a person is non-fatally injured in alcohol-related motor vehicle crashes. Those NHTSA-determined rates resulted in 16,885 deaths and approximately 261,700 injuries in 2005, with those deaths representing 39 percent of all traffic-related deaths. Tragically, of the 1,946 traffic fatalities among children ages 0 to 14 years in 2005, 21 percent involved alcohol, and more than half of the 414 child passengers ages 14 and younger who died in alcohol-related crashes during 2005 were riding with the impaired driver, according to the NHTSA statistics. For that same year, the Department of Justice reported that nearly 1.4 million drivers were arrested for driving under the influence of alcohol or narcotics. It has been estimated that the number of annual arrests represents less than 1 percent of the total number of offenders. It has been estimated that each year, alcohol-related crashes in the United States, alone, cost about $51 billion. A shocking 30 percent of Americans will be involved in alcohol-related accidents during their lives.

For a number of years, it appeared that the war against drunk driving was being slowly won. Between 1993 and 1997, the number of alcohol-related accidents dropped more than 1 percent a year from 123 million to 116 million. However, the number of drunk driving accidents in the United States rose 37% between 1997 and 1999, and continued to rise sharply in subsequent years. By the year 2002, the number had reached an alarming 159 million alcohol-related accidents. Not surprisingly, the number of deaths also increased. From 1999 to 2003, the number of deaths due to drunk driving crashes rose approximately 2.5 percent to 17,013. Auto accidents are the leading cause of death in Americans under the age of 34, according to CDC findings. The economic burden of these accidents totals more than $50 billion each year.

Alcohol intoxication is legally defined as a percentage concentration of alcohol in the blood in excess of a statutory limit. For years, the legal standard for drunkenness across the United States was 0.10 percent for years. However, as a result of prodding by the federal government, all states have now adopted the 0.08 percent standard. Given the impractical and invasive procedures required to obtain blood or urine samples in the field for later analysis in the laboratory, as well as the inevitable time lag required to obtain results which would be needed to justify the arrest of drivers suspected of driving while impaired (DWI) or driving under the influence (DUI), a method of determining blood alcohol concentration independent of blood and urine samples was needed.

Ethanol that a person drinks is absorbed into the bloodstream from the mouth, throat, stomach and intestines into the bloodstream. Ethanol is not metabolized or chemically altered in the bloodstream after being absorbed. Although both ethanol and water will evaporate from an aqueous solution containing ethanol that is exposed to the air, the ethanol evaporates at a faster rate because it more volatile than water. Thus, as the blood circulates through the lungs, some of the ethanol passes through the membranes of the alveoli (the lung's air sacs) and into the air. The concentration of the alcohol in the alveolar air is related to the concentration of the alcohol in the blood. As the alcohol in the alveolar air is exhaled, it can be detected by a breath alcohol testing device. The ratio of breath to blood alcohol is 2,100 to 1. This means that 2,100 milliliters of alveolar air will contain the same amount of alcohol as 1 milliliter of blood. In the 1940s, the first breath alcohol testing devices were developed for use by the police. Then, in 1954, Dr. Robert Borkenstein of the Indiana State Police invented the Breathalyzer, one type of breath alcohol testing device still used by law enforcement agencies today. Rather than having to draw a driver's blood to test his alcohol level, an officer can test the breath on the spot using a breath analyzer and determine whether that individual's BAC exceeds the legal limit.

There are three major types of breath alcohol testing devices currently in use, each of which is based upon a different principle. A Breathalyzer® uses a chemical reaction involving alcohol that produces a color change; an Intoxilyzer® detects alcohol by infrared (IR) spectroscopy; and an Alcosensor® III or IV detects a chemical reaction of alcohol in a fuel cell. Regardless of the type, each device has a mouthpiece or tube through which the suspect can blow alveolar air and a sample chamber where the exhaled air is collected.

The great number of undocumented aliens in this country—who have no permanent ties to this country—compounds the difficulty of dealing with individuals who drive under the influence. It is likely that the increase in the number of drunk driving cases in recent years can be attributed to the large numbers of illegals in this country. A number of high-profile cases have aired on national news, where drunk undocumented aliens driving pick-up trucks, have crashed into and killed entire familes riding in high-occupancy vehicles such as minivans. The large numbers of illegal aliens—may of whom drive unlicensed, giving little head to DUI statutes—are virtually immune to punitive action, other than jail or prison time. If arrested and granted bail, they simply return to Mexico to escape prosecution.

For those who have established roots within the country, one of the more promising tools available to courts for combating alcohol-impaired driving is the breath alcohol automotive ignition system interlock.

A breath alcohol ignition interlock device (BIID or IID) is a tamper-resistant device similar to a breathalyzer which is coupled to a vehicle's ignition system. Before the vehicle can be started, the driver must breathe into the device. The alveolar air is collected in a chamber and analyzed. If the device determines blood alcohol concentration exceeds a programed concentration (commonly 0.02% or 0.04%), the device logs the event and disables the ignition. At random times after the engine has been started, the IID will require another breath sample. The purpose of this is to prevent a friend from breathing into the device at start-up, thereby enabling an intoxicated person to get behind the wheel and drive away. If the breath sample isn't provided, or the sample exceeds the ignition interlock's preset blood alcohol level, the device will log the event, warn the driver and then trigger an alarm (e.g., lights flashing, horn honking, etc.) until the ignition is turned off. A common misconception is that interlock devices simply turn off the engine if alcohol is detected. This, however, might create an unsafe driving condition, thereby exposing interlock manufacturers to tort liability. One of the few weaknesses of the IID is that an inebriated driver may compel another occupant of the vehicle—typically an underage child—to provide passable breath samples, both for start-up and follow-up.

Modern ignition interlock devices typically consist of a handheld device having a small keyboard, a mouthpiece, a collection chamber, and an ethanol-specific fuel cell sensor; and a dashboard device containing a microprocessor, random access memory, non-volatile memory for storage of event logging, and ignition interlock circuitry controlled by the microprocessor that is hardwired to the vehicle ignition system using tamperproof connectors. The fuel cell sensor is an electrochemical device in which alcohol undergoes a chemical oxidation reaction at a catalytic electrode surface to generate an electrical current. The fuel cell has two platinum electrodes with a porous acid electrolyte material sandwiched between them. As the exhaled air from the suspect flows past one side of the fuel cell, the platinum oxidizes any alcohol in the air to produce acetic acid, protons and electrons. The electrons flow through a wire from the platinum electrode. The wire is connected to an electrical current meter and to the platinum electrode on the other side. The protons move through the lower portion of the fuel cell and combine with oxygen and the electrons on the other side to form water. The more alcohol that becomes oxidized, the greater the electrical current. A microprocessor measures the electrical current and calculates the BAC. Although fuel cell technology is not as accurate or reliable as infrared spectroscopy technology used in evidentiary breathalyzers, it is cheaper and tends to be more specific for alcohol.

An IID typically has a The devices keep a record of the activity on the device and the interlocked vehicle's electrical system. This record, or log, is printed out or downloaded each time the device's sensors are calibrated, commonly at 30, 60, or 90 day intervals. Authorities may require periodic review of the log. If violations are detected, then additional sanctions can be implemented. Periodic calibration is performed using either a pressurized alcohol/gas mixture at a known alcohol concentration, or with an alcohol wet bath arrangement that contains a known alcohol solution. The costs of installation, maintenance and calibration are generally paid by the offender, and typically are about $75 per month.

A list of federally-approved IID devices is maintained by the National Highway Traffic Safety Administration in its NHTSA Conforming Products List. Among approved manufacturers of IIDs are LifeSafer Interlock, Smart Start Inc, SOS, Ignition Interlock Systems, Intoxalock and Monitech. Many countries are requiring the installation of ignition interlock devices as a penalty for drivers convicted of driving under the influence, and particularly for those who are repeat offenders. The laws in most states in the U.S. now permit judges to order the installation of an IID as a condition of probation. For repeat offenders, and even for first offenders in some states, installation may be mandatory. Despite the claims of critics that IIDs are inaccurate, ineffective and dangerous, Mothers Against Drunk Driving (MADD) launched a highly publicized campaign in November 2006 advocating mandatory IID installation for all first offenders. Some politicians in countries throughout the world, including some in the U.S., have called for such devices to be installed as standard equipment in all motor vehicles sold.

One of the problems associated with the use of ignition interlock devices is that of condensation. If ambient temperatures are too low, condensation will form within the mouthpiece and collection chamber of the device, resulting in a false reading and/or a delay while sufficient evaporation takes place so that a normal accurate reading can be made of the exhaled air. As the heater of the vehicle cannot be operated until the engine is running, the IID precludes use of the vehicle heater to warm the mouthpiece and collection chamber. The only option available to a monitored driver is to disconnect the handheld unit, which includes the mouthpiece and collection chamber, and place it in a warm room until it is needed. Unfortunately, by the time the handheld unit is transported to the vehicle and reconnected, it may have cooled down sufficiently to the extent that condensation is, once again, a problem. What is needed is a method and apparatus for maintaining the handheld unit of an IID at a temperature sufficient to prevent condensation within the mouthpiece and collection chamber at the time of use.

### SUMMARY OF THE INVENTION

A primary object of the present invention is to provide an electrically-heated insulated warming bag in which the handheld unit of an ignition interlock device can be stored while not in use. The walls of the warming bag are comprised of an outer cover layer and a pair of insulation layers having resistive wiring sandwiched between them. The bag preferably has an opening that is sealable with hook and loop fastener material. Both insulation layers may be of the same thickness or, alternatively, the innermost insulation layer may be thinner than the layer that is adjacent the outer cover layer. The latter arrangement facilitates more rapid heat transfer into the interior of the bag. The warming bag has a power cord fitted with a plug that engages a cigarette lighter socket, or other similar automotive electrical power outlet. The warming bay may be equipped with an optional thermostat that maintains a set temperature with minimum consumption of electrical power. The temperature setting can be adjusted to compensate for variations in humidity levels, which are affected by local climate and the time of year. The outer cover layer may be woven fabric material, fabric-backed plasticized polyvinylchloride sheet material, or other similar material. The insulation layers may be a synthetic woven fabric or pressed felt made of aramid fibers, such as Nomex®, a synthetic woven fabric or pressed felt made of an organic fiber of copolyamide, aluminized rayon, Armaflux thermal fabric available from Armstrong World Industries of Lancaster, Pa., aluminized fiberglass or other similar and/or equivalent material. Aluminized insulation layers are preferably positioned immediately adjacent the outer cover layer to better prevent the escape of heat from the warming bag. The innermost insulation layer is preferably not aluminized so that heat can more easily transfer to the interior of the warming bag. The resistive wiring pattern is prevented from shifting between the insulation layers by coating the adjacent faces of the innermost inlation layer and the outermost insulation layer with flexible rubber contact cement or some other adhesive having similar qualities of flexibility and adhesion.

### BRIEF DESCRIPTION OF THE DRAWINGS

FIG. 1 is a plan view of a first embodiment electrically-heated, insulated warming bag for an ignition system interlock device in an unfolded and unsewn configuration;

FIG. 2 is a plan view of a second embodiment electrically-heated, insulated warming bag for an ignition system interlock device in an unfolded and unsewn configuration;

FIG. 3 is a plan view of either the first or second embodiment electrically-heated, insulated warming bag for an ignition system interlock device in a folded and sewn configuration; and

FIG. 4 is an elevational view of a first set of material layers from which the electrically-heated, insulated warming bag for an ignition system interlock device is fabricated; and

FIG. 5 is an elevational view of an alternative second set of material layers from which the insulated warming bag is fabricated.

### DETAILED DISCLOSURE OF THE INVENTION

The present invention provides an electrically-heated insulated warming bag in which the handheld unit of an ignition interlock device can be stored while not in use. The walls of the warming bag are comprised of an outer cover layer and a pair of insulation layers having resistive wiring sandwiched between them. The bag preferably has an opening that is sealable with hook and loop fastener material. The warming bag has an electrical cord fitted with a plug that engages an automotive electrical power outlet. The electrically-heated insulated warming bag will now be described in detail with reference to the attached drawing figures.

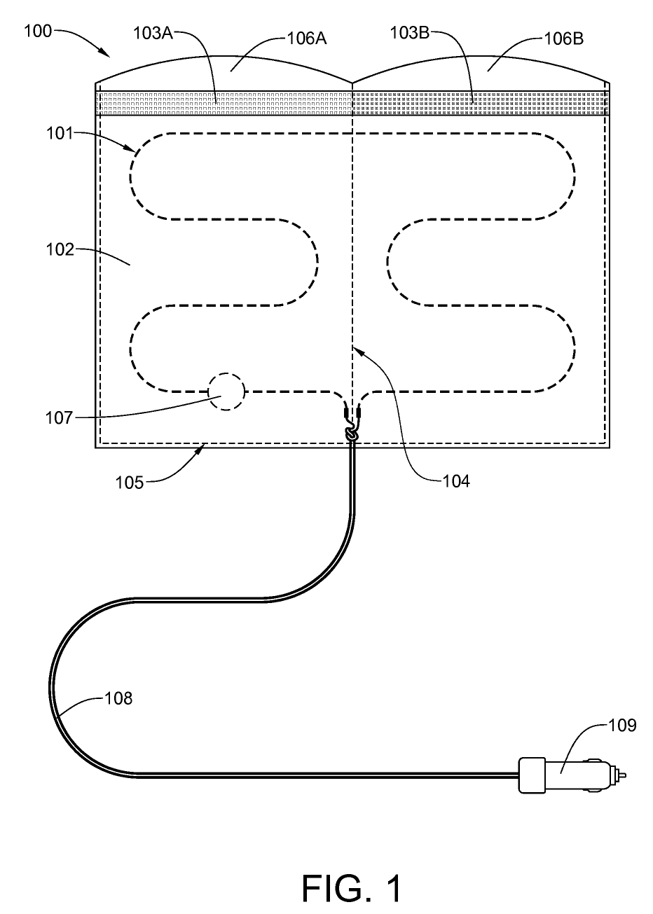

Referring now to FIG. 1, a first embodiment partially-completed, electrically-heated insulated warming bag 100 having a first embodiment wiring pattern is shown. The snaked resistance wire 101, which may be, for example, insulated high-resistance nickel-chromium alloy, is sandwiched between a pair of insulation layers. Only the inner insulation layer 102 is visible in this view. An outer cover layer, which is on the bottom of the stack and, hence, not visible in this view, may be woven fabric material, fabric-backed plasticized polyvinylchloride sheet material, or other similar material. The resistance wire 101 is shown as a broken line because it is hidden from view by the inner insulation layer 102. First and second strips 103A and 103B, respectively, of opposite gender hook and loop fastener material are sewn to an upper portion of the inner insulation layer 102. Dashed line 104 represents a central fold line. After the inner insulation layer 102 is folded over on itself along line 104, causing first and second strips 103A and 103B to overlap and form a seal, the edges will be sewn together along dashed line 105. It will be noted that the upper portions 106A and 106 of the bag layers are curved to facilitate grasping them and pulling apart the first and second strips 103A and 103B in order to gain access to the interior of the finished bag. The warming bay may be equipped with an optional thermostat 107 that maintains a set temperature with minimum consumption of electrical power. The temperature setting can be adjusted to compensate for variations in humidity levels, which are affected by local climate and the time of year. The warming bag has a power cord 108 fitted with a plug 109 that engages a cigarette lighter socket, or other similar automotive electrical power outlet.

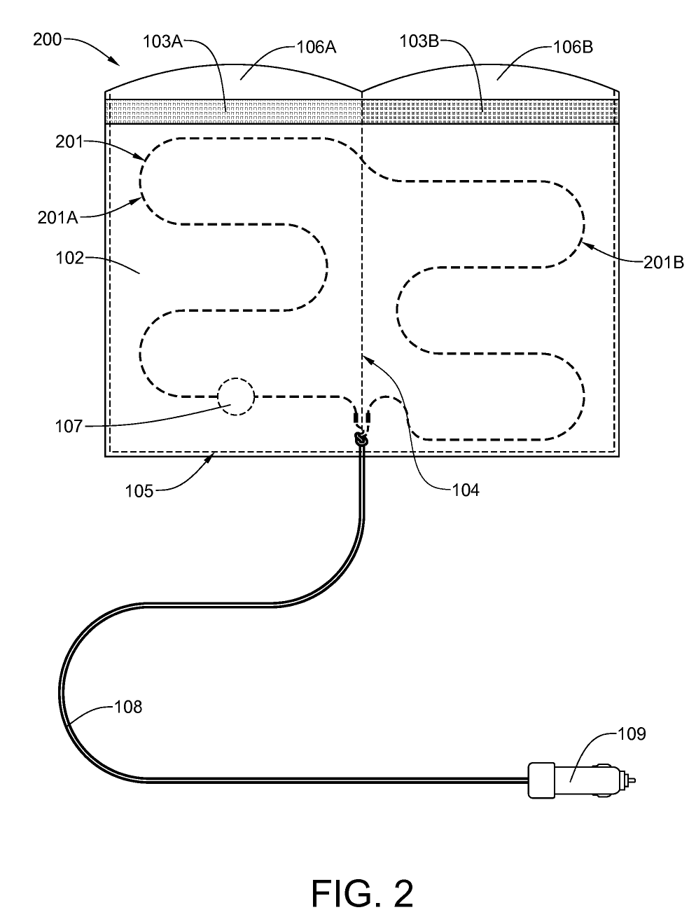

Referring now to FIG. 2, a second embodiment partially-completed, electrically-heated warming bag 200 is identical to the first embodiment warming bag of FIG. 1, with the exception that the first embodiment wiring pattern is shown. The snaked resistance wire 201 is routed differently so that a first half of the wiring pattern 201A on one side of the bag 200 is largely offset from a second half of the wire pattern 201 B on the other side of the bag 200.

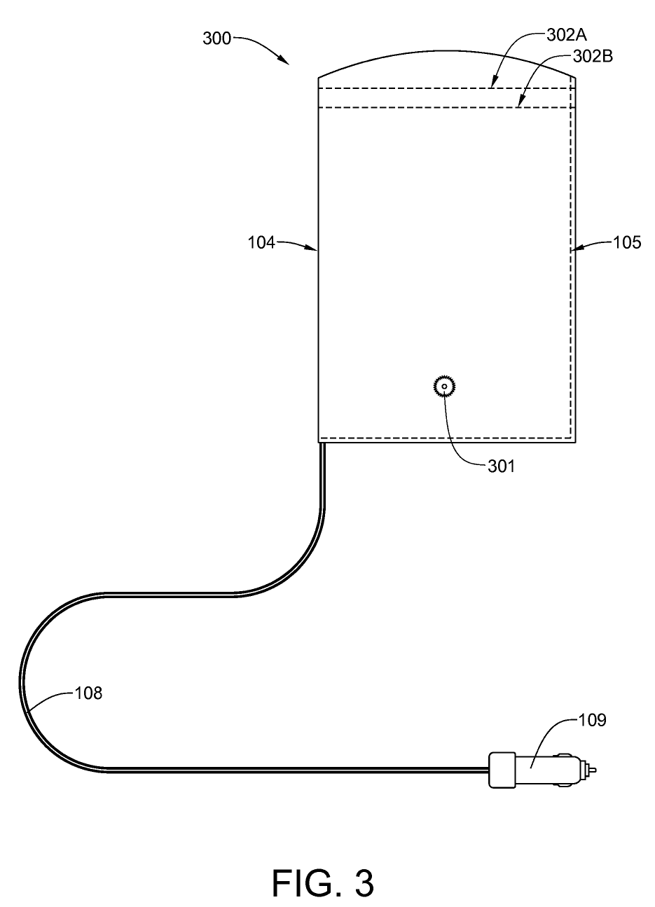

Referring now to FIG. 3, the first or second embodiment partially-completed, electrically-heated warming bag 100 or 200, respectively has been folded along line 104 and stitched along a lower edge and a side edge corresponding to line 105, resulting in a completed electrically-heated warming bag 300. It will be noted that a control knob 301 of the thermostat 107 projects outside the wall of the bag 300 so that the temperature setting can be easily changed. The stitching lines 302A and 302B correspond to the stitching used to secure the first strip 103A of the fastener material to the inner insulation layer 102.

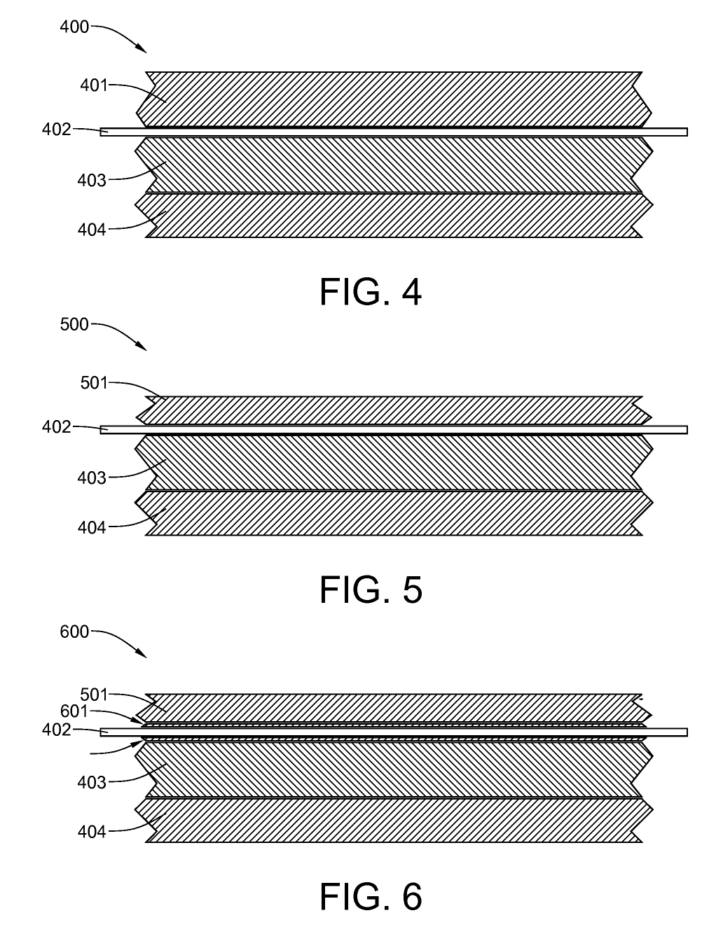

Referring now to FIG. 4, a first ordered set of material layers 400 from which the electrically-heated, insulated warming bag for an ignition system interlock device may be fabricated include an innermost insulation layer 401, the insulated resistive wiring 402, an outmost insulation layer 403, and an outer cover layer 404. The outer cover layer 404 may be woven fabric material, fabric-backed plasticized polyvinylchloride sheet material, or other similar material. The insulation layers 401 and 403 may be a synthetic woven fabric or pressed felt made of aramid fibers, such as Nomex®, a synthetic woven fabric or pressed felt made of an organic fiber of copolyamide, aluminized rayon, Armaflux thermal fabric available from Armstrong World Industries of Lancaster, Pa., aluminized fiberglass or other similar and/or equivalent material. Aluminized insulation layers are preferably positioned immediately adjacent the outer cover layer to better prevent the escape of heat from the warming bag. The innermost insulation layer 401 is preferably not aluminized so that heat can more easily transfer to the interior of the warming bag. The resistive wiring pattern is prevented from shifting between the insulation layers 401 and 403 by coating the adjacent faces of the innermost insulation layer 401 and the outermost insulation layer 403 with flexible rubber contact cement or some other adhesive having similar qualities of flexibility and adhesion.

Referring now to FIG. 5, a second ordered set of material layers 500 from which the electrically-heated, insulated warming bag for an ignition system interlock device may be fabricated is identical to the first ordered set 400 of FIG. 4, with the exception that the innermost insulation layer 501 of the second ordered set is thinner than the innermost insulation layer 401 of the first ordered set 400. This ensures that heat transfer from the resistive wiring layer 402 to the interior of the completed warming bag 300 will occur at a faster rate than heat transfer to the exterior of the bag.

Referring now to FIG. 6, the resistive wiring pattern is prevented from shifting between the insulation layers 501 and 403 of a modified second ordered set of material layers 600 by coating the adjacent faces of the innermost insulation layer 501 and the outermost insulation layer 403 with flexible rubber contact cement 601 or some other adhesive having similar qualities of flexibility and adhesion. The same technique may be applied to the first ordered set of material layers 400 of FIG. 4.

Although only a single embodiment of the present invention has been disclosed herein, it will be obvious to those having ordinary skill in the art that changes and modifications may be made thereto without departing from the scope and spirit of the invention as hereinafter may be claimed.

What is claimed is:

1. A warming bag for storing the handheld unit of an ignition interlock device while the latter is not in use so that it can be removed from the bag and used immediately without generating device read errors caused by internal condensation, the warming bag comprising:
a wall having inner and outer insulation layers;
resistive wire pattern sandwiched between said inner and outer insulation layers;
a power cord connected to said resistive wire pattern;
a plug coupled to said power cord which engages an automotive power receptacle; and
a sealable opening.

2. The warming bag of claim 1, wherein said resistive wire pattern is prevented from shifting its position relative to said inner and outer insulation layers by an adhesive layer which bonds together said inner and outer insulation layers.

3. The warming bag of claim 1, which further comprises an outer cover which encloses said inner and outer insulation layers and said resistive wire pattern.

5. The warming bag of claim 1, which further comprises first and second strips of opposite gender hook and loop fastener material sewn to opposite sides of said opening, said hook and loop fastener material providing means for sealing said opening.

6. The warming bag of claim 1, wherein said resistive wire pattern comprises insulated nickel-chromium alloy wire.

7. The warming bag of claim 1, wherein said bag is fabricated from a layer stack comprising a single inner insulation layer piece, a single outer insulation piece, and a length of resistive wire, each end of which is coupled to said power cord, said layer stack being folded about a center line and sewn together around one side and one bottom edge to form the bag.

8. The warming bag of claim 1, which further comprises a thermostat that maintains a set temperature and minimizes consumption of electrical power.

9. The warming bag of claim 8, wherein a temperature setting of the thermostat can be adjusted to compensate for variations in humidity levels, which are affected by local climate and the time of year.

10. The warming bag of claim 8, wherein said thermostat is adjustable from outside the bag.

11. A method of fabricating a warming bag for storing the handheld unit of an ignition interlock device while the latter is not in use so that it can be removed from the bag and used immediately without generating device read errors caused by internal condensation, said method comprising the steps of:
creating a generally rectangular multilayer stack including an outer cover layer, an outer insulation layer, a resistive wiring pattern layer, and an inner insulation layer;
folding said multilayer stack about a centerline; and
sewing together a lower edge and a side edge of the folded multilayer stack to form a bag having an upper opening.

12. The method of claim 11, which further comprises the step of applying an adhesive layer between the outer insulation layer and the inner insulation layer, said adhesive layer preventing the resistive wiring pattern layer from shifting between the two insulation layers.

13. The method of claim 11, which further comprises the step of coupling said resistive wiring pattern to a power cord, which extends from one corner of the bag.

14. The method of claim 11, which further comprises the step of installing a thermostat in said multilayer stack, said thermostat providing a temperature-controlled switch between two portions of said resistive wiring pattern.

15. The method of claim 14, which further comprises the step of providing a control for said thermostat which is accessible on an outer surface of said bag.

16. The method of claim 11, which further comprises the step of providing a plug at an end of the power cord, said plug engageable with an automotive power outlet.

17. The method of claim 11, which further comprises the step of providing closure means for said opening.

18. The method of claim 17, wherein said closure means comprises two strips of opposite gender hook and loop fastener material sewn to opposite sides of said opening.

19. The method of claim 18, wherein said strips of hook and loop fastener material are sewn below an upper edge of said opening so as to facilitate grasping of the opening edges and pulling apart said strips of hook and loop fastener material.

20. The method of claim 12, wherein said adhesive layer is flexible rubber contact cement.
